(19) United States
(12) Patent Application Publication
(10) Pub. No.: US 2026/0104185 A1
(43) Pub. Date: Apr. 16, 2026

(54) MOTOR COOLING SYSTEM

(71) Applicant: Mazda Motor Corporation, Hiroshima (JP)

(72) Inventors: Kazuki Yamagishi, Aki-gun (JP); Yoshitomo Takahashi, Aki-gun (JP)

(21) Appl. No.: 19/347,987

(22) Filed: Oct. 2, 2025

(30) Foreign Application Priority Data
Oct. 15, 2024 (JP) 2024-179813

(51) Int. Cl. F25B 9/00; B60K 1/00; F25B 31/00; H02K 5/167; H02K 9/19; H02K 11/21

(52) U.S. Cl. CPC F25B 9/006; B60K 1/00; F25B 9/008; F25B 31/002; H02K 5/1672; H02K 9/19; H02K 11/21; B60K 2001/006; F25B 2500/16; F25B 2700/03

(57) ABSTRACT

In a motor cooling system that cools a motor by using a refrigerant in which oil is contained in CO₂, the oil in the motor is reliably discharged. The motor cooling system mounted on a vehicle includes a compressor for compressing the refrigerant in which the oil is contained in CO₂; a heat exchanger for cooling the refrigerant compressed by the compressor; the motor for driving the vehicle; refrigerant passages for supplying the refrigerant cooled by the heat exchanger into the motor; and a controller controlling the compressor, and the controller controls the compressor to generate the refrigerant in a supercritical state such that the refrigerant in the supercritical state is supplied from the refrigerant passage into the motor when a supercritical refrigerant supply condition is satisfied.

### TECHNICAL FIELD

The present disclosure relates to a motor cooling system for cooling a motor of a vehicle.

### BACKGROUND ART

In recent years, small and high-performance motors have been developed by practical application of electric vehicles. For this high-performance motor, in particular, improvements in output and torque per volume are requested. In addition, with the improvements in the motor output and torque, it is required to cool the motor with high efficiency. Techniques such as air cooling, water cooling, and oil cooling of the motors have been developed in response to this demand.

As a method for cooling the motor, a method for directly supplying a refrigerant to the motor is considered. For example, JP2022-114761A discloses a motor cooling structure of cooling a magnet that is embedded in a rotor of the motor by using a refrigerant (such as an Automatic Transmission Fluid (ATF)). This motor cooling structure forms a refrigerant passage that extends from a motor shaft toward the magnet in the rotor, and cools the magnet by supplying the refrigerant from this passage.

### SUMMARY

### Technical Problem

Here, when the motor is cooled by using the refrigerant, a method for supplying the refrigerant between the rotor and a stator of the motor is considered. In this case, stirring resistance by the refrigerant between the rotor and the stator changes in a quadratic curve according to a motor rotational frequency. That is, as the motor rotational frequency is increased, the stirring resistance becomes extremely high. Accordingly, the high resistance tends to be generated in the motor that is operated at ultra-high rotation such as that in the electric vehicle. In particular, when a high-viscosity refrigerant is adopted as the refrigerant, the extremely high resistance is generated.

In view of the above, the present inventors have considered to achieve both a reduction in the stirring resistance and improvement in cooling performance by using a refrigerant composed of low-viscosity CO₂ (hereinafter referred to as a “CO₂ refrigerant” or simply referred to as a “refrigerant”). Such a CO₂ refrigerant has a high insulation property, is a so-called natural refrigerant, and thus is designed to give special consideration to the environment and human bodies.

However, the refrigerant as described above usually contains a small amount of oil (such as polyalkylene glycol (PAG)). This is because a compressor is used to bring the refrigerant supplied to the motor to a desired state, and the oil is required for lubrication in this compressor. Meanwhile, lubricant oil is also used for a bearing that supports a rotation shaft of the motor. Due to the above reasons, not only CO₂ but also the oil enters the motor, that is, the oil enters a gap between the rotor and the stator. As a result, an oil film (in other words, an oil reservoir) is formed in the gap, and a problem of an increase in the stirring resistance occurs.

The present disclosure has been made to solve the above-described problems in the related art, and an object of the present disclosure is to reliably discharge oil in a motor in a motor cooling system for cooling the motor by using a refrigerant that contains oil in CO₂.

### Solution to Problem

In order to achieve the above object, the present disclosure provides a motor cooling system mounted on a vehicle, and the motor cooling system includes a compressor for compressing a refrigerant in which oil is contained in CO_{2,} a heat exchanger for cooling the refrigerant that is compressed by the compressor, a motor for driving the vehicle, a refrigerant passage for supplying the refrigerant cooled by the heat exchanger into the motor to cool the motor, and a controller for at least controlling the compressor, in which the controller is configured to control the compressor to generate the refrigerant in a supercritical state such that the refrigerant in the supercritical state is supplied from the refrigerant passage into the motor when a predetermined condition is satisfied.

According to this configuration, the refrigerant in the supercritical state is supplied into the motor, and it is thereby possible to take in the oil in the motor by the refrigerant and to effectively discharge the oil together with the refrigerant by utilizing a compatibility of the refrigerant in this supercritical state. In this way, an oil film (in other words, an oil reservoir) formed in the motor can be removed to suppress an increase in stirring resistance caused by the oil in the motor.

In the present disclosure, preferably, the controller is configured to control the compressor to generate the refrigerant in the supercritical state when the predetermined condition is satisfied, and control the compressor to generate the refrigerant in a liquid phase state when the predetermined condition is not satisfied.

According to this configuration, the controller restricts a situation where the refrigerant in the supercritical state is supplied, that is, does not unnecessarily supply the refrigerant in the supercritical state by supplying the refrigerant in the liquid phase state into the motor when the predetermined condition is not satisfied. As a result, a load of the compressor for generating the refrigerant in the supercritical state can be reduced, and an increase in resistance due to supply of the refrigerant in the supercritical state into the motor can be suppressed.

In the present disclosure, preferably, when the predetermined condition is satisfied and thereafter a predetermined time has elapsed since a start of the supply of the refrigerant in the supercritical state into the motor, the controller is configured to control the compressor to terminate the supply of the refrigerant in the supercritical state and generate the refrigerant in the liquid phase state in order to supply the refrigerant in the liquid phase state into the motor.

According to this configuration, the supply of the refrigerant in the supercritical state is terminated when the discharge of the oil in the motor is completed by supplying the refrigerant in the supercritical state for a certain period of time. As a result, the load of the compressor for generating the refrigerant in the supercritical state can be reduced. That is, power consumption by the compressor can be suppressed.

In the present disclosure, preferably, the refrigerant passage includes a first passage for supplying the refrigerant in the supercritical state into the motor and a second passage for supplying the refrigerant in the liquid phase state into the motor, the motor cooling system further includes a valve provided in the first passage and/or the second passage, and the controller is configured to control the valve to supply the refrigerant in the supercritical state from the first passage into the motor when the predetermined condition is satisfied and to control the valve to supply the refrigerant in the liquid phase state from the second passage into the motor when the predetermined condition is not satisfied.

According to this configuration, it is possible to easily switch the refrigerant to be supplied into the motor between the refrigerant in the supercritical state and the refrigerant in the liquid phase state by controlling the valve to switch the passage (the first passage and the second passage) through which the refrigerant flows.

In the present disclosure, preferably, the motor cooling system further includes a motor rotational frequency sensor that detects a rotational frequency of the motor, and the controller is configured to determine that the predetermined condition is satisfied when the rotational frequency (a motor rotational frequency) detected by the motor rotational frequency sensor is lower than a predetermined rotational frequency.

According to this configuration, it is possible to supply the refrigerant in the supercritical state during low rotation of the motor and thus to effectively suppress an increase in resistance caused by the supply of the refrigerant in the supercritical state into the motor.

In the present disclosure, preferably, when the predetermined condition is satisfied and thereafter the rotational frequency has become equal to or higher than the predetermined rotational frequency while the refrigerant in the supercritical state is supplied into the motor, the controller is configured to control the compressor to terminate the supply of the refrigerant in the supercritical state and generate the refrigerant in the liquid phase state in order to supply the refrigerant in the liquid phase state into the motor.

According to this configuration, it is possible to suppress power consumption by the compressor by terminating operation of the compressor for generating the refrigerant in the supercritical state when the motor rotational frequency is increased (typically during acceleration). As a result, electric power can be supplied to the motor, and an acceleration request of the vehicle can be accurately fulfilled.

In the present disclosure, preferably, the motor cooling system further includes at least one of an acceleration sensor detecting acceleration of the vehicle, a camera capturing an image of surroundings of the vehicle, a distance sensor detecting a distance between the vehicle and an object present therearound, or a GPS sensor detecting a current position of the vehicle, and the controller is configured to predict a stop of the vehicle on the basis of a signal acquired from at least one of the acceleration sensor, the camera, the distance sensor, or the GPS sensor and to determine that the predetermined condition is satisfied when the stop of the vehicle is predicted.

According to this configuration, in consideration of the fact that it takes a certain time to generate the refrigerant in the supercritical state in the compressor, the operation of the compressor for generating the refrigerant in the supercritical state is started in advance at a timing of predicting the stop of the vehicle before the rotational frequency of the motor actually becomes low. In this way, it is possible to reliably supply the refrigerant in the supercritical state during the low rotation of the motor and to reliably and simultaneously suppress the increase in the resistance caused by the supply of the refrigerant in the supercritical state into the motor and secure oil discharge in the motor by the refrigerant in the supercritical state.

In the present disclosure, preferably, the motor cooling system further includes a pedal sensor that detects a pedal operation by a driver for applying a braking force to the vehicle, and the controller is configured to determine that the predetermined condition is satisfied when the pedal operation is detected by the pedal sensor.

Similarly to the above, according to this configuration, in consideration of the fact that it takes the certain time to generate the refrigerant in the supercritical state in the compressor, the operation of the compressor for generating the refrigerant in the supercritical state is started in advance at timing of detecting the pedal operation for braking the vehicle by the pedal sensor before the rotational frequency of the motor actually becomes low. In this way, it is possible to reliably supply the refrigerant in the supercritical state during the low rotation of the motor and to reliably and simultaneously suppress the increase in the resistance caused by the supply of the refrigerant in the supercritical state into the motor and secure the oil discharge in the motor by the refrigerant in the supercritical state.

In the present disclosure, preferably, the motor cooling system further includes an oil tank that stores the oil, and an oil level sensor that detects a level of the oil stored in the oil tank, and the controller is configured to determine that the predetermined condition is satisfied when the level detected by the oil level sensor is equal to or higher than a first predetermined value and lower than a second predetermined value that is higher than the first predetermined value.

According to this configuration, when control for supplying the refrigerant in the supercritical state is executed on the basis of a determination result of the oil level using the first predetermined value and the second predetermined value, it is possible to reliably discharge the oil in the motor while preventing seizure or the like of the compressor caused by insufficient oil in the refrigerant in a situation where there is a relatively large amount of the oil in the motor.

In the present disclosure, in a preferred example, the motor includes a rotor, a stator, a rotation shaft coupled to the rotor, and a slide bearing supporting the rotation shaft, and is configured to supply the refrigerant from the refrigerant passage between the rotor and the stator, and the motor cooling system includes, in addition to the refrigerant passage: a refrigerant passage for supplying the refrigerant to the slide bearing; and an oil passage for supplying the oil to the slide bearing.

### Advantageous Effects

According to the present disclosure, in the motor cooling system that cools the motor by using the refrigerant in which the oil is contained in CO₂, the oil in the motor can be reliably discharged.

### BRIEF DESCRIPTION OF DRAWINGS

FIG. 1 is a schematic configuration view of a vehicle to which a motor cooling system according to an embodiment of the present disclosure is applied.

FIG. 2 is a schematic configuration view of the motor cooling system according to the embodiment of the present disclosure.

FIG. 3 is a schematic configuration view in which vicinity of a motor in the motor cooling system according to the embodiment of the disclosure is enlarged.

FIG. 4 is a block diagram illustrating an electrical configuration of the motor cooling system according to the embodiment of the disclosure.

FIG. 5 is a time chart illustrating control according to the embodiment of the present disclosure.

FIG. 6 is a flowchart illustrating the control according to the embodiment of the present disclosure.

FIG. 7 is a time chart illustrating control according to a modified example of the embodiment of the present disclosure.

FIG. 8 is a flowchart illustrating the control according to the modified example of the embodiment of the present disclosure.

### DETAILED DESCRIPTION

Hereinafter, a motor cooling system according to an embodiment of the present disclosure will be described with reference to the accompanying drawings.

### Overall Configuration

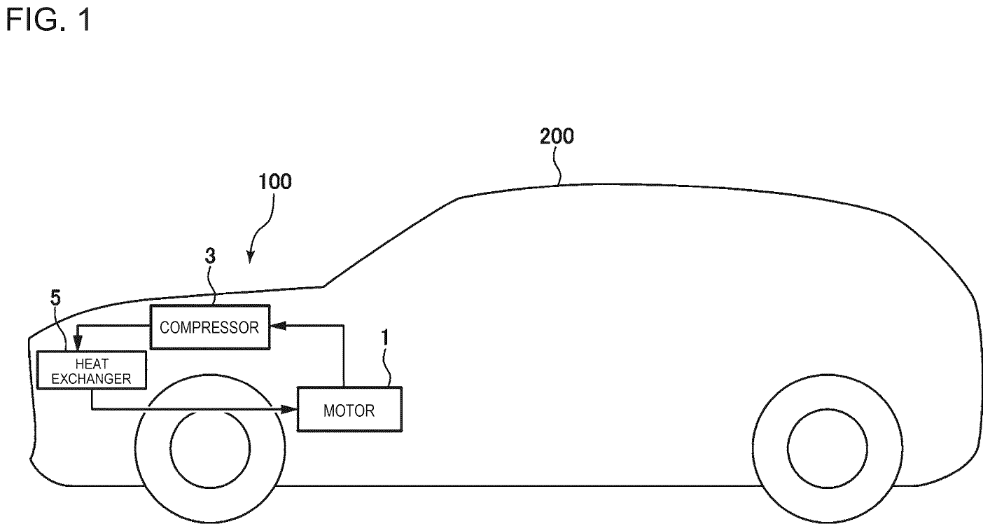

First, FIG. 1 is a schematic configuration view of a vehicle to which the motor cooling system according to the present embodiment is applied.

As illustrated in FIG. 1, a vehicle 200 is an electric vehicle, for example, and has a motor cooling system 100. This motor cooling system 100 mainly includes a motor (an electric motor) 1 that generates power for driving the vehicle 200, a compressor 3 that compresses a refrigerant to be supplied to the motor 1, and a heat exchanger 5 that includes a condenser, a fan, and the like and cools the refrigerant compressed by the compressor 3.

The motor cooling system 100 circulates the refrigerant in a refrigeration cycle, more specifically, circulates a CO₂ refrigerant (hereinafter, also simply referred to as the “refrigerant”) as a natural refrigerant. This CO₂ refrigerant contains not only CO₂ but also oil (refrigerant oil) such as polyalkylene glycol (PAG) (may further contain an additive or the like). Due to use of such a CO₂ refrigerant, the compressor 3 is configured to compress the refrigerant at an extremely high pressure. The motor 1 uses the refrigerant (typically a liquid refrigerant), which is thus-compressed by the compressor 3, to cool a rotor and a stator and to lubricate a slide bearing that supports a rotation shaft. In this case, the motor 1 is configured to function as an expansion valve or an evaporator in the refrigeration cycle. For example, in the motor cooling system 100, a high-temperature liquid refrigerant is supplied from the compressor 3 to the heat exchanger 5, a low-temperature liquid refrigerant is supplied from the heat exchanger 5 to the motor 1, and a high-temperature gas refrigerant is supplied from the motor 1 to the compressor 3. The refrigerant that is compressed by the compressor 3 may be used for air conditioning by an air conditioner, cooling of a battery, or the like.

### Configuration of Motor Cooling System

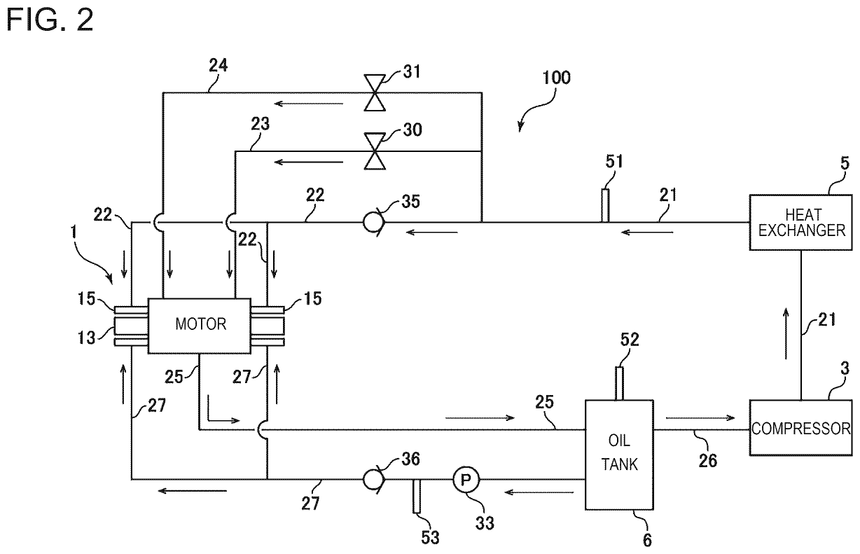

Next, a specific description will be made on the motor cooling system 100 according to the present embodiment with reference to FIGS. 2 to 4.

First, FIG. 2 is a schematic configuration view of the motor cooling system 100 according to the present embodiment. As illustrated in FIG. 2, the motor cooling system 100 mainly includes, in addition to the motor 1, the compressor 3, and the heat exchanger 5 described above an oil tank 6 that stores the oil, refrigerant passages 21 to 24, 26 through each of which the refrigerant (the CO₂ refrigerant) flows, a mixed fluid passage 25 through which a mixed fluid of the refrigerant and the oil flows, and an oil passage 27 through which the oil flows. In addition, as illustrated in FIG. 2, the motor 1 includes a rotation shaft 13 and a pair of slide bearings 15 that supports the rotation shaft 13.

The refrigerant passage 21 is a passage for supplying the refrigerant from the compressor 3 to the motor 1 and the like via the heat exchanger 5, and is branched into the refrigerant passage 22, the refrigerant passage 23, and the refrigerant passage 24 downstream of the heat exchanger 5. A refrigerant pressure sensor 51 that detects a pressure of the refrigerant is provided in the refrigerant passage 21.

Hereinafter, description with respect to FIG. 2 will be made to mainly one of the slide bearings 15 as a representative example of the pair. The refrigerant passage 22 is a passage for supplying the refrigerant into the slide bearing 15, and the refrigerant passages 23, 24 are passages for supplying the refrigerant into the motor 1. In particular, the refrigerant passage 23 is a passage for supplying the refrigerant in a liquid phase state into the motor 1 (an example of a “second passage” in the present disclosure), and the refrigerant passage 24 is a passage for supplying the refrigerant in a supercritical state into the motor 1 (an example of a “first passage” in the present disclosure). The refrigerant supplied from the refrigerant passage 22 to the slide bearing 15 is used to lubricate the slide bearing 15, the refrigerant supplied from the refrigerant passage 23 to the motor 1 is used to cool inside of the motor 1, and the refrigerant supplied from the refrigerant passage 24 to the motor 1 is used to discharge the oil in the motor 1.

A check valve 35 is provided in the refrigerant passage 22. Furthermore, the refrigerant passage 23 is provided with a cooling valve 30 capable of switching supply/blockage of the refrigerant by the passage by opening and closing, and the refrigerant passage 24 is provided with a discharge valve 31 capable of switching supply/blockage of the refrigerant by the passage by opening and closing.

Here, the present disclosure is not limited to providing the valves (the cooling valve 30 and the discharge valve 31) in the refrigerant passages 23, 24, respectively, that is, the present disclosure is not limited to the use of the two valves. In another example, a valve may be provided in either one of the refrigerant passages 23, 24, or a three-way valve may be provided at a branch point of the refrigerant passages 23, 24, and the refrigerant may thereby flow through corresponding one of the refrigerant passages 23, 24 by using such a single valve.

The mixed fluid passage 25 is a passage for supplying the mixed fluid of the refrigerant discharged from the inside of the motor 1 and the oil to the oil tank 6. The oil tank 6 is configured to separate the oil in the mixed fluid supplied from this mixed fluid passage 25 (gas-liquid separation) and store the separated oil while supplying the remaining refrigerant (containing a slight amount of the oil) from the refrigerant passage 26 to the compressor 3. The oil tank 6 is provided with an oil level sensor 52 that detects a level of the stored oil.

The oil passage 27 is a passage for supplying the oil stored in the oil tank 6 to the slide bearing 15. The oil supplied to the slide bearing 15 is used to lubricate the slide bearing 15 together with the refrigerant described above. The oil passage 27 is provided with an oil pump 33 for pressure-feeding the oil, a hydraulic pressure sensor 53 that detects a pressure of the oil, and a check valve 36.

In the motor cooling system 100 as described above, since the refrigerant is supplied (more specifically, jetted) from the refrigerant passages 23, 24 into the motor 1 and the pressure thereof is reduced, the motor 1 functions as an expansion valve in the refrigeration cycle. In addition, since the thus-supplied refrigerant exchanges heat in the motor 1, (the refrigerant absorbs heat and is evaporated at this time), the motor 1 functions as an evaporator in the refrigeration cycle.

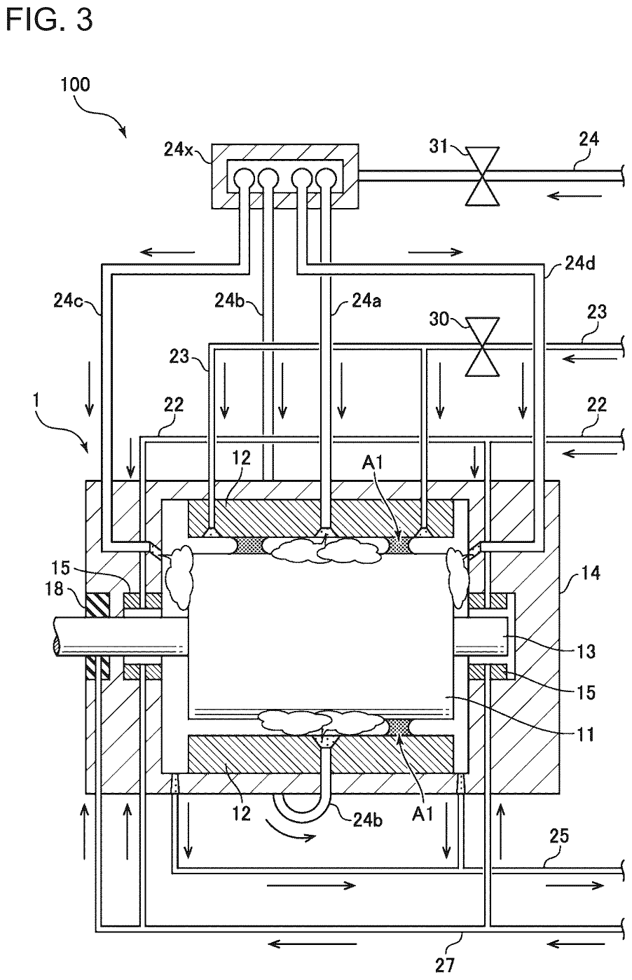

Next, FIG. 3 is a schematic configuration view in which vicinity of the motor 1 in the motor cooling system 100 according to the present embodiment is enlarged. More specifically, FIG. 3 is a cross-sectional view in which the motor 1 is viewed along an axial direction. Here, FIG. 3 schematically illustrates a state where the refrigerant in the supercritical state is supplied from the refrigerant passage 24 into the motor 1.

As illustrated in FIG. 3, the motor 1 of the motor cooling system 100 includes a rotor 11, a stator 12, the rotation shaft 13 coupled to the rotor 11 and having one end connected to a transaxle (not illustrated) of the vehicle 200 or the like, the pair of the slide bearings 15 that supports the rotation shaft 13 of the motor 1, and a housing 14 that accommodates the rotor 11, stator 12, rotation shaft 13, and slide bearings 15.

In addition, the housing 14 of the motor 1 is provided with a seal member 18 for sealing a side of the rotation shaft 13 connected to the transaxle or the like (a side provided with one of the slide bearings 15 and illustrated on the left in FIG. 3). This seal member 18 is provided to prevent leakage of a fluid from a gap between the housing 14 and a portion of the rotation shaft 13 extending outward from the housing 14. The seal member 18 is configured as a mechanical seal that is supplied with the oil from the oil passage 27 and uses this oil to prevent the leakage of the fluid.

As further illustrated in FIG. 3, in the motor cooling system 100, the refrigerant passage 22 is configured to supply the refrigerant to each of the paired slide bearings 15 in the motor 1, and the refrigerant passage 23 is configured to supply the refrigerant (the refrigerant in the liquid phase state) to a gap between the rotor 11 and the stator 12 in the motor 1. In particular, the refrigerant passage 23 is branched into two passages downstream of the cooling valve 30, and supplies the refrigerant from these two passages to the gap between the rotor 11 and the stator 12.

In addition, the refrigerant passage 24 is branched into four refrigerant passages 24a to 24d in a branch section 24x downstream of the discharge valve 31, and is configured to supply the refrigerant (the refrigerant in the supercritical state) from each of the refrigerant passages 24a to 24d into the motor 1. More specifically, the refrigerant passages 24a, 24b are configured to supply the refrigerant to the gap between the rotor 11 and the stator 12, in particular, a central portion in the axial direction of the rotor 11 and the stator 12, and the refrigerant passages 24c, 24d are configured to supply the refrigerant from the side of the rotor 11 and the stator 12.

Here, as described in “Solution to Problem” above, since the refrigerant (the CO₂ refrigerant) contains the oil, and since the oil is used for the slide bearings 15, not only CO₂ but also the oil enter the gap between the rotor 11 and the stator 12, and an oil film (in other words, an oil reservoir) is thereby formed in this gap (see arrows A1 in FIG. 3). As a result, a problem that stirring resistance is increased in the motor 1 occurs.

To handle such a problem, in the present embodiment, the refrigerant in the supercritical state is supplied from the refrigerant passage 24 into the motor 1. Since the refrigerant in the supercritical state has a high compatibility with the oil, it is possible to effectively take in the oil. Accordingly, when the refrigerant in the supercritical state is supplied to the gap between the rotor 11 and the stator 12, the oil in this gap can be accurately taken in by the refrigerant, and the oil that has been taken in can be discharged together with the refrigerant from the mixed fluid passage 25. As a result, it is possible to prevent an increase in the stirring resistance by removing the oil film that is formed in the gap between the rotor 11 and the stator 12. In the present embodiment, by using the four refrigerant passages 24a to 24d, the refrigerant is supplied to a position where the stirring resistance is likely to be generated in the motor 1 (see a refrigerant supply state illustrated in FIG. 3).

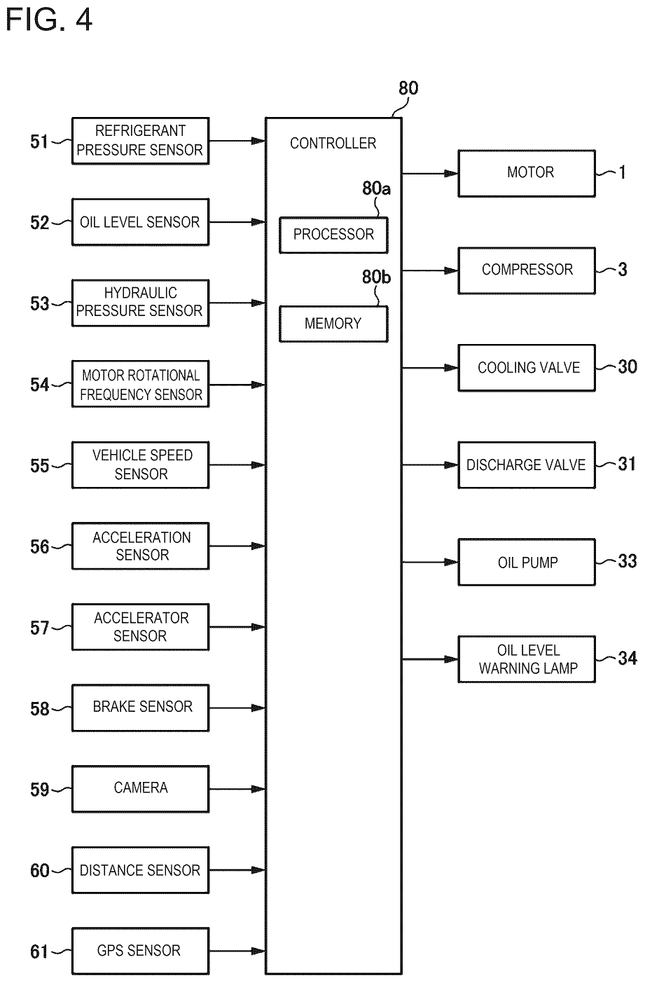

Next, an electrical configuration of the motor cooling system 100 according to the present embodiment will be described with reference to FIG. 4. FIG. 4 is a block diagram illustrating the electrical configuration of the motor cooling system 100 according to the present embodiment.

As illustrated in FIG. 4, the motor cooling system 100 includes a controller 80 configured to execute various types of control in the system. The controller 80 is configured with a computer that includes one or more processors 80a (typically central processing units (CPUs)), and memory 80b, such as read-only memory (ROM) and/or random access memory (RAM), that stores various programs (including a basic control program such as an operating system (OS) and an application program activated on the OS to implement a particular function) interpretively executed on the processor 80a and various types of data.

In addition to the sensors 51 to 53 (see FIG. 2) described above, the motor cooling system 100 also includes a motor rotational frequency sensor 54 that detects motor rotational frequencies in the motor 1 (rotational frequencies of the rotor 11 and the rotation shaft 13 and is synonymous with a rotation speed); a vehicle speed sensor 55 that detects a speed of the vehicle 200 (a vehicle speed); an acceleration sensor 56 that detects acceleration of the vehicle 200; an accelerator sensor 57 that detects an operation of an accelerator pedal (particularly, an accelerator pedal operation amount) in the vehicle 200; a brake sensor 58 that detects an operation of a brake pedal in the vehicle 200; a camera 59 that captures an image of surroundings (typically, the front) of the vehicle 200; a distance sensor 60 that detects a distance between the vehicle 200 and an object (typically a forward vehicle) present therearound; and a Global Positioning System (GPS) sensor 61 that detects a current position of the vehicle 200.

For example, the distance sensor 60 is a millimeter-wave radar, a laser radar, or an ultrasonic sensor, and LiDAR (Light Detection and Ranging) is typically used. The GPS sensor 61 includes a GPS receiver, a gyro sensor, and the like. The accelerator sensor 57 and the brake sensor 58 each are an example of a “pedal sensor” in the present disclosure.

The controller 80 supplies a control signal to the motor 1, the compressor 3, the cooling valve 30, the discharge valve 31, the oil pump 33, and an oil level warning lamp 34 on the basis of detection signals from these sensors 51 to 61. The oil level warning lamp 34 is a lamp for warning that the level of the oil stored in the oil tank 6 (detected by the oil level sensor 52) is less than a predetermined value.

In the present embodiment, the controller 80 mainly controls the compressor 3 to generate the refrigerant in the liquid phase state or the refrigerant in the supercritical state, and executes control for switching opening/closing of each of the cooling valve 30 and the discharge valve 31 to supply the refrigerant in the liquid phase state or the refrigerant in the supercritical state from the refrigerant passage 23 or the refrigerant passage 24 into the motor 1. The supercritical state is created by controlling the compressor 3 so that the pressure of the refrigerant is in the range of 7.4 MPa to 20 MPa and the temperature is in the range of 31° C. to 200° C. More specifically, the compressor 3 rotation speed that will result in a target pressure of 10 MPa and a target temperature of 200° C. is determined in advance, and the compressor 3 is controlled by the controller 80 to achieve this target compressor rotation speed.

### Control Method

Next, a specific description will be made on the control executed by the controller 80 of the motor cooling system 100 in the present embodiment.

In the present embodiment, the controller 80 determines whether to supply the refrigerant in the supercritical state into the motor 1 (this is to determine whether a “predetermined condition” is satisfied in the present disclosure). Then, when it is determined that the refrigerant in the supercritical state is to be supplied into the motor 1, it controls the compressor 3 to generate the refrigerant in the supercritical state, and executes control to close the cooling valve 30 and open the discharge valve 31 to supply the refrigerant in this supercritical state from the refrigerant passage 24 into the motor 1. In this way, the oil in the gap between the rotor 11 and the stator 12 is taken in by the refrigerant in the supercritical state supplied into the motor 1, and is discharged together with the refrigerant. Thus, the oil film (in other words, the oil reservoir) formed in the gap between the rotor 11 and the stator 12 is removed to prevent the increase in the stirring resistance.

On the other hand, when it is not determined that the refrigerant in the supercritical state is to be supplied into the motor 1, that is, when the refrigerant in the liquid phase state is to be supplied into the motor 1, the controller 80 controls the compressor 3 to generate the refrigerant in the liquid phase state, and executes control to open the cooling valve 30 and close the discharge valve 31 to supply the refrigerant in this liquid phase state from the refrigerant passage 23 into the motor 1. In this way, the refrigerant in the supercritical state is not unnecessarily supplied into the motor 1. As a result, a load of the compressor 3 for generating the refrigerant in the supercritical state is reduced, and an increase in resistance due to supply of the refrigerant in the supercritical state into the motor 1 is suppressed. When the refrigerant in the liquid phase state is supplied into the motor 1, the stirring resistance by the refrigerant tends to be lower than that when the refrigerant in the supercritical state is supplied into the motor 1. This is because, when the refrigerant in the liquid phase state is supplied into the motor 1, the refrigerant is changed from the liquid phase state to a gas phase state (including a gas-liquid mixed phase) in the motor 1.

In addition, when a predetermined time elapses since a start of the supply of the refrigerant in the supercritical state into the motor 1 as described above, the controller 80 controls the compressor 3 to terminate the supply of the refrigerant in the supercritical state and supply the refrigerant in the liquid phase state into the motor 1, and executes the control for switching opening/closing of each of the cooling valve 30 and the discharge valve 31. In this way, the supply of the refrigerant in the supercritical state is terminated when the discharge of the oil in the motor 1 is completed by supplying the refrigerant in the supercritical state for a certain time. Thus, the load of the compressor 3 for generating the refrigerant in the supercritical state is reduced. From such a viewpoint, the predetermined time is determined on the basis of a time for supplying the refrigerant in the supercritical state until completion of the discharge of the oil in the motor 1.

Furthermore, when a determination condition (an example of the “predetermined condition” in the present disclosure, and hereinafter appropriately referred to as a “supercritical refrigerant supply condition”) as exemplified below is satisfied, the controller 80 executes control for supplying the refrigerant in the supercritical state as described above into the motor 1. When this supercritical refrigerant supply condition is not satisfied, the controller 80 executes control for supplying the refrigerant in the liquid phase state into the motor 1. When supplying the refrigerant in the supercritical state, the controller 80 turns on a “discharge amount increase request flag” to increase a discharge amount by the compressor 3.

As a first example, the controller 80 determines that the supercritical refrigerant supply condition is satisfied when the motor rotational frequency, which is detected by the motor rotational frequency sensor 54, is lower than a predetermined rotational frequency. This is done to supply the refrigerant in the supercritical state during low rotation of the motor 1 for a purpose of suppressing the increase in the resistance caused by the supply of the refrigerant in the supercritical state into the motor 1. This is because the stirring resistance by the refrigerant becomes lower during the low rotation than during high rotation. From such a viewpoint, the controller 80 controls the compressor 3 to terminate the supply of the refrigerant in the supercritical phase and supply the refrigerant in the liquid phase state into the motor 1, and executes the control for switching opening/closing of each of the cooling valve 30 and the discharge valve 31 in the case where the motor rotational frequency becomes lower than the predetermined rotational frequency and thereafter the motor rotational frequency becomes higher than the predetermined rotational frequency while the refrigerant in the supercritical state is supplied into the motor 1. The predetermined rotational frequency described above is set on the basis of the motor rotational frequency at which the stirring resistance by the refrigerant (in particular, the refrigerant in the supercritical state) becomes lower than a predetermined value.

As a second example, the controller 80 predicts a stop of the vehicle 200 on the basis of a signal acquired from at least one of the acceleration sensor 56, the camera 59, the distance sensor 60, or the GPS sensor 61, and determines that the supercritical refrigerant supply condition is satisfied when predicting the stop of the vehicle 200. Also, in the second example, basically, the refrigerant in the supercritical state is supplied during the low rotation of the motor 1 for a purpose of suppressing the increase in the resistance caused by the supply of the refrigerant in the supercritical state into the motor 1. In particular, in this second example, in consideration of a fact that it takes a certain time to generate the refrigerant in the supercritical state by the compressor 3, the operation of the compressor 3 for generating the refrigerant in the supercritical state is started in advance at timing of predicting the stop of the vehicle 200 before the rotational frequency of the motor 1 actually becomes low (that is, before the vehicle 200 is almost stopped). When predicting the stop of the vehicle 200, just as described, the controller 80 turns on a “stop prediction flag.”

As a third example, the controller 80 determines that the supercritical refrigerant supply condition is satisfied when a pedal operation by a driver for applying a braking force to the vehicle 200 is detected, more specifically, when a depression operation of the brake pedal is detected by the brake sensor 58. Also, in the third example, basically, the refrigerant in the supercritical state is supplied during the low rotation of the motor 1 for the purpose of suppressing the increase in the resistance caused by the supply of the refrigerant in the supercritical state into the motor 1. In particular, in this third example, in consideration of the fact that it takes the certain time to generate the refrigerant in the supercritical state by the compressor 3, the operation of the compressor 3 for generating the refrigerant in the supercritical state is started in advance at timing of depressing the brake pedal before the rotational frequency of the motor 1 actually becomes low (that is, before the vehicle 200 is almost stopped).

As a fourth example, the controller 80 determines that the supercritical refrigerant supply condition is satisfied when the oil level detected by the oil level sensor 52 is equal to or higher than a first level (a first predetermined value) and lower than a second level (a second predetermined value) that is higher than the first level. Here, first, the case where the oil level is lower than the second level is a case where the oil level in the oil tank 6 is relatively low, and this can be said to mean that there is a relatively large amount of the oil in the motor 1. This case corresponds to a situation where the oil in the motor 1 should be discharged by the refrigerant in the supercritical state. Meanwhile, the case where the oil level is equal to or higher than the first level is a case where the refrigerant contains a sufficient amount of the oil for accurately operating the compressor 3. That is, when the compressor 3 is operated to generate the refrigerant in the supercritical state, the compressor 3 can be accurately lubricated with the oil contained in the refrigerant such that seizure or the like does not occur to the compressor 3. Just as described, when the control for supplying the refrigerant in the supercritical state is executed on the basis of the determination result of the oil level using the first level and the second level, it is possible to reliably discharge the oil in the motor 1 while preventing the seizure or the like of the compressor 3 caused by insufficient oil in the refrigerant in a situation where there is the relatively large amount of the oil in the motor 1.

In the above description, the four determination conditions are each exemplified as the supercritical refrigerant supply condition. However, the present disclosure is not limited to use of any one of these four determination conditions, and two or more of these our determination conditions are preferably used in combination.

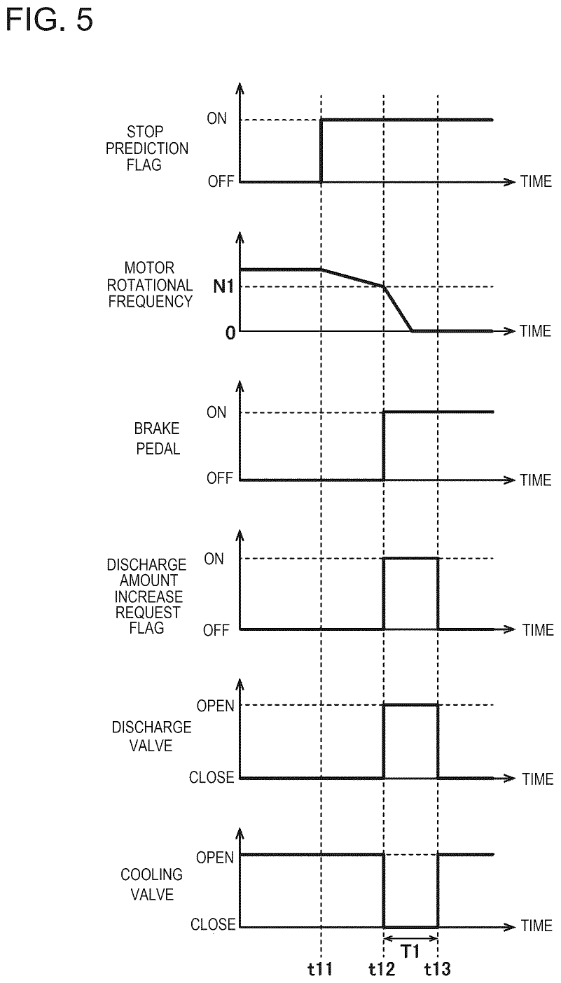

Next, a flow of the control executed by the controller 80 in the present embodiment will be described with reference to FIG. 5. FIG. 5 is a time chart illustrating the control according to the present embodiment. FIG. 5 illustrates, in an order from the top, temporal changes in on/off of the stop prediction flag, the motor rotational frequency, on/off of the brake pedal, on/off of the discharge amount increase request flag, opening/closing of the discharge valve 31, and opening/closing of a cooling valve 32. Here, a case where the first to third examples described above are used as the supercritical refrigerant supply conditions will be exemplified.

First, at time t11, the controller 80 predicts the stop of the vehicle 200 on the basis of the signal acquired from at least one of the acceleration sensor 56, the camera 59, the distance sensor 60, or the GPS sensor 61, and thereby turns on the stop prediction flag. Thereafter, at time t12, the motor rotational frequency becomes lower than a predetermined rotational frequency N1, and the brake pedal is turned on (that is, the brake pedal is depressed). At this time t12, the controller 80 turns on the discharge amount increase request flag, controls the compressor 3 to generate the refrigerant in the supercritical state, and executes the control to open the discharge valve 31 and close the cooling valve 30 in order to supply the refrigerant in this supercritical state from the refrigerant passage 24 into the motor 1.

Thereafter, at time t13, a predetermined time T1 elapses since the refrigerant in the supercritical state starts being supplied into the motor 1. Thus, at this time t13, the controller 80 terminates the supply of the refrigerant in the supercritical state and supplies the refrigerant in the liquid phase state into the motor 1. More specifically, the controller 80 turns off the discharge amount increase request flag, controls the compressor 3 to generate the refrigerant in the liquid phase state, and executes the control to close the discharge valve 31 and open the cooling valve 30 in order to supply the refrigerant in the liquid phase state from the refrigerant passage 23 into the motor 1.

When the brake pedal is depressed as described above, the motor 1 generates heat by a regenerative operation. At this time, since the discharge amount of the compressor 3 is increased and the amount of the refrigerant supplied to the motor 1 is increased, it is possible to accurately handle the heat generation by regeneration. In addition, regenerative electric power generated by the motor 1 can be used to increase work of the compressor 3.

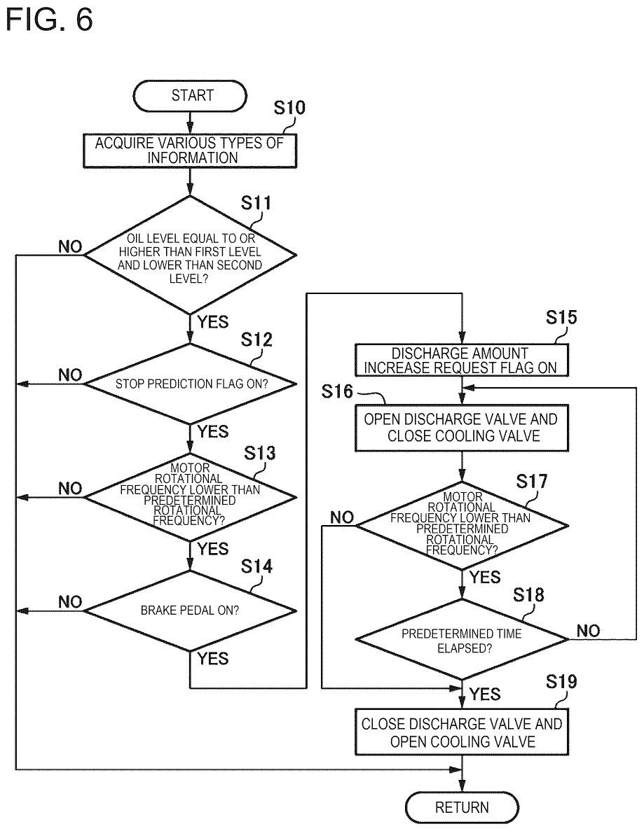

Next, a description will be made on a flowchart illustrating specific control according to the present embodiment with reference to FIG. 6. This flow is repeatedly executed by the controller 80 in a predetermined cycle. In detail, the processor 80a in the controller 80 reads the program stored in the memory 80b to execute the program, and thereby realizes the control according to this flow. Here, a case where the first to fourth examples described above are used as the supercritical refrigerant supply conditions will be exemplified.

First, in step S10, the controller 80 acquires various types of information such as the detection values detected by the sensors 51 to 61 (FIG. 4) described above. Then, the processing proceeds to step S11, and the controller 80 determines whether the oil level detected by the oil level sensor 52 is equal to or higher than the first level and is lower than the second level. As a result, if the controller 80 determines that the oil level is equal to or higher than the first level and is lower than the second level (step S11: Yes), the processing proceeds to step S12. On the other hand, if the controller 80 does not determine that the oil level is equal to or higher than the first level and is lower than the second level (step S11: No), that is, if the oil level is lower than the first level or equal to or higher than the second level, the control according to this flow is terminated. In this case, the controller 80 does not execute the control for supplying the refrigerant in the supercritical state into the motor 1 (the same applies hereinafter).

Next, in step S12, the controller 80 determines whether the stop prediction flag is on. Here, the controller 80 predicts the stop of the vehicle 200 on the basis of the signal acquired from at least one of the acceleration sensor 56, the camera 59, the distance sensor 60, or the GPS sensor 61. Then, if predicting the stop of the vehicle 200, the controller 80 turns on the stop prediction flag.

In one example, the controller 80 predicts the stop of the vehicle 200 when acceleration detected by the acceleration sensor 56 is reduced to be lower than a predetermined value (that is, when the vehicle 200 decelerates relatively significantly). In another example, the controller 80 predicts the stop of the vehicle 200 when a brake lamp of the forward vehicle, which is captured by the camera 59, is on, when a signal in front captured by the camera 59 is a red signal, or when a road sign in front captured by the camera 59 indicates a stop or the like. In yet another example, the controller 80 predicts the stop of the vehicle 200 when a distance to the forward vehicle, which is detected by the distance sensor 60, is reduced to be shorter than a predetermined value (corresponding to a case where the forward vehicle decelerates relatively significantly and an inter-vehicular distance is reduced). In yet another example, the controller 80 predicts the stop of the vehicle 200 when determining that the current position of the vehicle 200 is a point (an intersection, the signal, or a downhill) where the stop or the deceleration is required with reference to map data that is provided in a navigation system mounted on the vehicle 200, in addition to the current position of the vehicle 200 detected by the GPS sensor 61. The plurality of examples described herein may be appropriately implemented in combination.

As a result of step S12, if the controller 80 determines that the stop prediction flag is on (step S12: Yes), the processing proceeds to step S13. If it does not determine that the stop prediction flag is on (step S12: No), that is, if the stop prediction flag is off, the control according to this flow is terminated.

Next, in step S13, the controller 80 determines whether the motor rotational frequency detected by the motor rotational frequency sensor 54 is lower than the predetermined rotational frequency N1. As a result, if the controller 80 determines that the motor rotational frequency is lower than the predetermined rotational frequency N1 (step S13: Yes), the processing proceeds to step S14. If it does not determine that the motor rotational frequency is lower than the predetermined rotational frequency N1 (step S13: No), that is, if the motor rotational frequency is equal to or higher than the predetermined rotational frequency N1, the control according to this flow is terminated.

Next, in step S14, the controller 80 determines whether the brake pedal is on. In this case, the controller 80 determines whether the depression operation of the brake pedal is detected by the brake sensor 58. As a result, if the controller 80 determines that the brake pedal is on (step S14: Yes), that is, if the brake pedal is depressed, the processing proceeds to step S15. On the other hand, if the controller 80 does not determine that the brake pedal is on (step S14: No), that is, if the brake pedal is not depressed, the control according to this flow is terminated.

Next, in step S15, since all the conditions in steps S11 to S14 are satisfied, that is, since the supercritical refrigerant supply condition is satisfied, the controller 80 turns on the discharge amount increase request flag, and controls the compressor 3 to generate the refrigerant in the supercritical state. Then, in step S16, the controller 80 executes the control for opening the discharge valve 31 and closing the cooling valve 30 to supply the refrigerant in the supercritical state from the refrigerant passage 24 into the motor 1.

Next, in step S17, the controller 80 determines whether the motor rotational frequency detected by the motor rotational frequency sensor 54 is lower than the predetermined rotational frequency N1. As a result, if the controller 80 does not determine that the motor rotational frequency is lower than the predetermined rotational frequency N1 (step S17: No), that is, if the motor rotational frequency is equal to or higher than the predetermined rotational frequency N1, the processing proceeds to step S19. In step S19, the controller 80 executes the control for closing the discharge valve 31 and opening the cooling valve 30 to terminate the supply of the refrigerant in the supercritical state and to supply the refrigerant in the liquid phase state from the refrigerant passage 23 into the motor 1. At this time, the controller 80 turns on the discharge amount increase request flag, and executes the control for the compressor 3 to generate the refrigerant in the liquid phase state. Then, the controller 80 terminates the control according to this flow.

On the other hand, if the controller 80 determines that the motor rotational frequency is lower than the predetermined rotational frequency N1 (step S17: Yes), the processing proceeds to step S18, and determines whether the predetermined time T1 has elapsed since the refrigerant in the supercritical state starts being supplied into the motor 1. As a result, if the controller 80 determines that the predetermined time T1 has elapsed (step S18: Yes), the processing proceeds to step S19, executes the same control as described above, and terminates the control according to this flow. On the other hand, if the controller 80 does not determine that the predetermined time T1 has elapsed (step S18: No), the processing returns to step S16. In this case, the controller 80 keeps supplying the refrigerant in the supercritical state.

In the above-described flow, when the supercritical refrigerant supply condition is determined, the four types of the determination processing in steps S11 to S14 are executed. However, the present disclosure is not limited to execution of all of these four types of the determination processing, and at least one of these four types of the determination processing only needs to be executed.

### Operation and Effects

Next, operation and effects of the motor cooling system 100 according to the present embodiment will be described.

In the present embodiment, the motor cooling system 100 that is mounted on the vehicle 200 includes the compressor 3 for compressing the refrigerant in which the oil is contained in CO₂, the heat exchanger 5 for cooling the refrigerant that is compressed by the compressor 3; the motor 1 for driving the vehicle 200, the refrigerant passages 23, 24 for supplying the refrigerant cooled by the heat exchanger 5 into the motor 1, and the controller 80 configured to control the compressor 3. The controller 80 controls the compressor 3 to generate the refrigerant in the supercritical state such that the refrigerant in the supercritical state is supplied from the refrigerant passage 24 into the motor 1 when the supercritical refrigerant supply condition is satisfied.

According to the present embodiment, the refrigerant in the supercritical state is supplied into the motor 1, and it is thereby possible to take in the oil in the motor 1 by the refrigerant and to effectively discharge the oil together with the refrigerant by utilizing the compatibility of the refrigerant in this supercritical state. In this way, the oil film (in other words, the oil reservoir) formed in the motor 1 (in particular, the gap between the rotor 11 and the stator 12) can be removed to suppress the increase in the stirring resistance caused by the oil in the motor 1.

In addition, in the present embodiment, the controller 80 is configured to control the compressor 3 to generate the refrigerant in the supercritical state when the supercritical refrigerant supply condition is satisfied, and to control the compressor 3 to generate the refrigerant in the liquid phase state when the supercritical refrigerant supply condition is not satisfied. In such a present embodiment, the controller 80 restricts the situation where the refrigerant in the supercritical state is supplied, that is, does not unnecessarily supply the refrigerant in the supercritical state. As a result, the load of the compressor 3 for generating the refrigerant in the supercritical state can be reduced, and the increase in the resistance due to the supply of the refrigerant in the supercritical state into the motor 1 can be suppressed.

Furthermore, in the present embodiment, when the supercritical refrigerant supply condition is satisfied and thereafter the predetermined time T1 has elapsed since the start of the supply of the refrigerant in the supercritical state into the motor 1, the controller 80 is configured to control the compressor 3 to terminate the supply of the refrigerant in the supercritical state and generate the refrigerant in the liquid phase state in order to supply the refrigerant in the liquid phase state into the motor 1. In this way, the supply of the refrigerant in the supercritical state can be terminated when the discharge of the oil in the motor 1 is completed by supplying the refrigerant in the supercritical state for the certain time, and it is thus possible to reduce the load of the compressor 3 for generating the refrigerant in the supercritical state. That is, power consumption by the compressor 3 can be suppressed.

In the present embodiment, the motor cooling system 100 includes the refrigerant passage 23 for supplying the refrigerant in the liquid phase state into the motor 1, the refrigerant passage 24 for supplying the refrigerant in the supercritical state into the motor 1, the cooling valve 30 provided in the refrigerant passage 23, and the discharge valve 31 provided in the refrigerant passage 24. The controller 80 is configured to control the discharge valve 31 to supply the refrigerant in the supercritical state from the refrigerant passage 24 into the motor 1 when the supercritical refrigerant supply condition is satisfied and to control the cooling valve 30 to supply the refrigerant in the liquid phase state from the refrigerant passage 24 into the motor 1 when the supercritical refrigerant supply condition is not satisfied. In this way, it is possible to easily switch the refrigerant to be supplied into the motor 1 between the refrigerant in the supercritical state and the refrigerant in the liquid phase state by controlling the cooling valve 30 and the discharge valve 31 to switch the passage (the refrigerant passages 23, 24) through which the refrigerant flows.

In the present embodiment, the motor cooling system 100 further includes the motor rotational frequency sensor 54 that detects the motor rotational frequency, and the controller 80 is configured to determine that the supercritical refrigerant supply condition is satisfied when the motor rotational frequency is lower than the predetermined rotational frequency N1. In this way, it is possible to supply the refrigerant in the supercritical state during the low rotation of the motor 1 and thus to effectively suppress the increase in the resistance caused by the supply of the refrigerant in the supercritical state into the motor 1.

In the present embodiment, in the case where the supercritical refrigerant supply condition is satisfied and the motor rotational frequency has become equal to or higher than the predetermined rotational frequency N1 while the refrigerant in the supercritical state is supplied into the motor 1, the controller 80 is configured to control the compressor 3 to terminate the supply of the refrigerant in the supercritical state and generate the refrigerant in the liquid phase state in order to supply the refrigerant in the liquid phase state into the motor 1. In this way, it is possible to suppress the power consumption by the compressor 3 by terminating the operation of the compressor 3 for generating the refrigerant in the supercritical state when the motor rotational frequency is increased (typically during the acceleration). As a result, the electric power can be supplied to the motor 1, and an acceleration request of the vehicle 200 can be accurately fulfilled.

In the present embodiment, the motor cooling system 100 further includes at least one of the acceleration sensor 56 for detecting the acceleration of the vehicle 200, the camera 59 for capturing the image of the surroundings of the vehicle 200, the distance sensor 60 for detecting the distance between the vehicle 200 and the object present therearound, or the GPS sensor 61 for detecting the current position of the vehicle 200, and the controller 80 is configured to predict the stop of the vehicle 200 on the basis of the signal acquired from at least one of the acceleration sensor 56, the camera 59, the distance sensor 60, or the GPS sensor 61 and determine that the supercritical refrigerant supply condition is satisfied when the stop of the vehicle 200 is predicted. In such a present embodiment, in consideration of the fact that it takes the certain time to generate the refrigerant in the supercritical state in the compressor 3, the operation of the compressor 3 for generating the refrigerant in the supercritical state is started in advance at the timing of predicting the stop of the vehicle 200 before the rotational frequency of the motor 1 actually becomes low. In this way, it is possible to reliably supply the refrigerant in the supercritical state during the low rotation of the motor 1 and to reliably and simultaneously suppress the increase in the resistance caused by the supply of the refrigerant in the supercritical state into the motor 1 and secure the oil discharge in the motor 1 by the refrigerant in the supercritical state.

In the present embodiment, the motor cooling system 100 further includes the brake sensor 58 that detects the brake pedal operation by the driver for applying the braking force to the vehicle 200, and the controller 80 is configured to determine that the supercritical refrigerant supply condition is satisfied when the brake pedal operation is detected by the brake sensor 58. Also, in such a present embodiment, in consideration of the fact that it takes the certain time to generate the refrigerant in the supercritical state in the compressor 3, the operation of the compressor 3 for generating the refrigerant in the supercritical state is started in advance at the timing of depressing the brake pedal before the rotational frequency of the motor 1 actually becomes low. In this way, it is possible to reliably supply the refrigerant in the supercritical state during the low rotation of the motor 1 and to reliably and simultaneously suppress the increase in the resistance caused by the supply of the refrigerant in the supercritical state into the motor 1 and secure the oil discharge in the motor 1 by the refrigerant in the supercritical state.

In the present embodiment, the motor cooling system 100 further includes: the oil tank 6 that stores the oil; and the oil level sensor 52 that detects the level of the oil stored in the oil tank 6, and the controller 80 is configured to determine that the supercritical refrigerant supply condition is satisfied when the oil level detected by the oil level sensor 52 is equal to or higher than the first level and lower than the second level (>the first level). When the control for supplying the refrigerant in the supercritical state is executed on the basis of the determination result of the oil level using the first level and the second level, just as described, it is possible to reliably discharge the oil in the motor 1 while preventing the seizure or the like of the compressor 3 caused by insufficient oil in the refrigerant in the situation where there is the relatively large amount of the oil in the motor 1.

### Modified Examples

In the embodiment described above, as the third example of the supercritical refrigerant supply condition, the condition of whether the pedal operation has been performed by the driver to apply the braking force to the vehicle 200 is used. In particular, in the third example, the depression operation of the brake pedal detected by the brake sensor 58 is used as the pedal operation by the driver for applying the braking force to the vehicle 200. In this third example, it is assumed to apply the present disclosure to a vehicle in which a so-called two-pedal operation is performed. In the two-pedal operation, the driving force is applied to the vehicle by depressing the accelerator pedal, and the braking force is applied to the vehicle by depressing the brake pedal. On the contrary, in the modified example, the present disclosure is applied to a vehicle in which a so-called one-pedal operation is performed. In the one-pedal operation, the driving force is applied to the vehicle by depressing the accelerator pedal, and the braking force is applied to the vehicle by releasing the accelerator pedal. In this modified example, the controller 80 determines the supercritical refrigerant supply condition by using a releasing operation of the accelerator pedal detected by the accelerator sensor 57 as the pedal operation by the driver for applying the braking force to the vehicle 200.

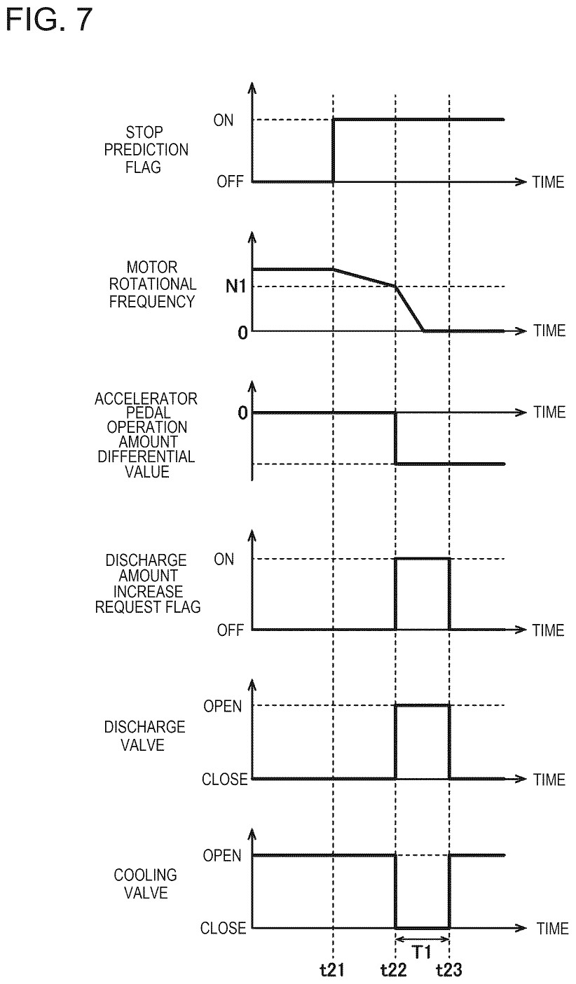

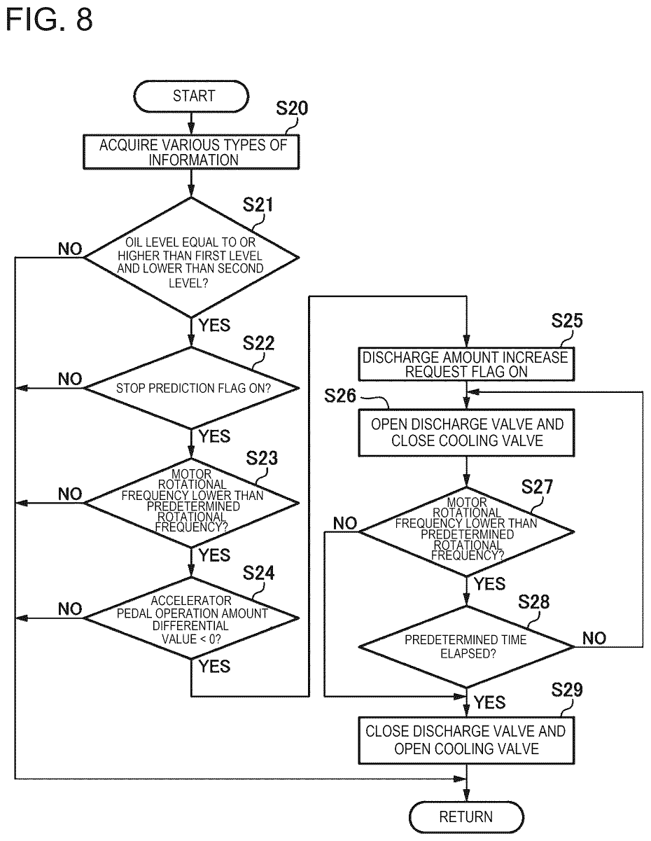

A specific description will be made on a control method according to such a modified example with reference to FIGS. 7 and 8. First, FIG. 7 is a time chart illustrating the control according to the modified example. FIG. 7 illustrates, in an order from the top, the temporal changes in on/off of the stop prediction flag, the motor rotational frequency, a differential value of the accelerator pedal operation amount, on/off of the discharge amount increase request flag, opening/closing of the discharge valve 31, and opening/closing of the cooling valve 32. Here, only differences from the control method (FIG. 5) according to the above-described embodiment will be described.

In the modified example, at time t22 after t21, the differential value of the accelerator pedal operation amount detected by the accelerator sensor 57 becomes smaller than 0. This means that the braking force starts being applied to the vehicle 200 by releasing the accelerator pedal in the vehicle 200 in which the so-called one-pedal operation is performed. At time t22, the stop prediction flag is on, and the motor rotational frequency is lower than the predetermined rotational frequency N1. Accordingly, at time t22 until t23, the controller 80 turns on the discharge amount increase request flag, controls the compressor 3 to generate the refrigerant in the supercritical state, and executes the control to open the discharge valve 31 and close the cooling valve 30 in order to supply the refrigerant in this supercritical state from the refrigerant passage 24 into the motor 1.

Next, FIG. 8 is a flowchart illustrating the control according to the modified example of the embodiment of the present disclosure. This flow is also repeatedly executed by the controller 80 in the predetermined cycle. In detail, the processor 80a in the controller 80 reads the program stored in the memory 80b to execute the program, and thereby realizes the control according to this flow.

Since steps S20 to S23 and S25 to S29 in FIG. 8 are the same as steps S10 to S13 and S15 to S19 in FIG. 6, respectively, the description on these will not be made, and the description will be mainly made on step S24. In step S24, the controller 80 calculates the differential value of the accelerator pedal operation amount detected by the accelerator sensor 57, and determines whether this differential value is smaller than 0. Here, the controller 80 determines whether the accelerator pedal is released in the vehicle 200 in which the so-called one-pedal operation is performed. As a result of step S24, if the controller 80 determines that the differential value of the accelerator pedal operation amount is smaller than 0 (step S24: Yes), the processing proceeds to step S25. If it does not determine that the differential value of the accelerator pedal operation amount is smaller than 0 (step S24: No), that is, if the accelerator pedal is not released, the control according to this flow is terminated.

Also, in such a modified example, in consideration of the fact that it takes the certain time to generate the refrigerant in the supercritical state in the compressor 3, the operation of the compressor 3 for generating the refrigerant in the supercritical state is started in advance at timing of releasing the accelerator pedal before the rotational frequency of the motor 1 actually becomes low. As a result, it is possible to reliably supply the refrigerant in the supercritical state during the low rotation of the motor 1 and to reliably and simultaneously suppress the increase in the resistance caused by the supply of the refrigerant in the supercritical state into the motor 1 and secure the oil discharge in the motor 1 by the refrigerant in the supercritical state.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims. Further, if used herein, the phrase “and/or”means either or both of two stated possibilities.

### Reference Character List

1: motor
3: compressor
5: heat exchanger
6: oil tank
11: rotor
12: stator
13: rotation shaft
15: slide bearing
21 to 24, 26: refrigerant passage
25: mixed fluid passage
27: oil passage
30: cooling valve
31: discharge valve
80: controller
100: motor cooling system
200: vehicle

What is claimed is:

1. A motor cooling system mounted on a vehicle, the motor cooling system comprising:
a compressor for compressing a refrigerant in which oil is contained in CO₂;
a heat exchanger for cooling the refrigerant that is compressed by the compressor;
a motor for driving the vehicle;
a refrigerant passage for supplying the refrigerant cooled by the heat exchanger into the motor to cool the motor; and
a controller for at least controlling the compressor, wherein
the controller is configured to control the compressor to generate the refrigerant in a supercritical state such that the refrigerant in the supercritical state is supplied from the refrigerant passage into the motor when a predetermined condition is satisfied.

2. The motor cooling system according to claim 1, wherein the controller is configured to control the compressor to generate the refrigerant in the supercritical state when the predetermined condition is satisfied, and control the compressor to generate the refrigerant in a liquid phase state when the predetermined condition is not satisfied.

3. The motor cooling system according to claim 1, wherein when the predetermined condition is satisfied and thereafter a predetermined time has elapsed since a start of the supply of the refrigerant in the supercritical state into the motor, the controller is configured to control the compressor to terminate supply of the refrigerant in the supercritical state and generate the refrigerant in a liquid phase state in order to supply the refrigerant in the liquid phase state into the motor.

4. The motor cooling system according to claim 1, wherein
the refrigerant passage includes a first passage for supplying the refrigerant in the supercritical state into the motor and a second passage for supplying the refrigerant in a liquid phase state into the motor,
the motor cooling system further comprises a valve provided in the first passage and/or the second passage, and
the controller is configured to control the valve to supply the refrigerant in the supercritical state from the first passage into the motor when the predetermined condition is satisfied, and control the valve to supply the refrigerant in the liquid phase state from the second passage into the motor when the predetermined condition is not satisfied.

5. The motor cooling system according to claim 1 further comprising:
a motor rotational frequency sensor that detects a rotational frequency of the motor, wherein
the controller is configured to determine that the predetermined condition is satisfied when the rotational frequency detected by the motor rotational frequency sensor is lower than a predetermined rotational frequency.

6. The motor cooling system according to claim 5, wherein when the predetermined condition is satisfied and thereafter the rotational frequency has become equal to or higher than the predetermined rotational frequency while the refrigerant in the supercritical state is supplied into the motor, the controller is configured to control the compressor to terminate supply of the refrigerant in the supercritical state and generate the refrigerant in a liquid phase state in order to supply the refrigerant in the liquid phase state into the motor.

7. The motor cooling system according to claim 1 further comprising:
at least one of an acceleration sensor detecting acceleration of the vehicle, a camera capturing an image of surroundings of the vehicle, a distance sensor detecting a distance between the vehicle and an object present therearound, or a GPS sensor detecting a current position of the vehicle, wherein
the controller is configured to predict a stop of the vehicle on the basis of a signal acquired from at least one of the acceleration sensor, the camera, the distance sensor, or the GPS sensor, and determine that the predetermined condition is satisfied when the stop of the vehicle is predicted.

8. The motor cooling system according to claim 1 further comprising:
a pedal sensor that detects a pedal operation by a driver for applying a braking force to the vehicle, wherein
the controller determines that the predetermined condition is satisfied when the pedal operation is detected by the pedal sensor.

9. The motor cooling system according to claim 1 further comprising:
an oil tank that stores the oil; and
an oil level sensor that detects a level of the oil stored in the oil tank, wherein
the controller is configured to determine that the predetermined condition is satisfied when the level detected by the oil level sensor is equal to or higher than a first predetermined value and lower than a second predetermined value that is higher than the first predetermined value.

10. The motor cooling system according to claim 1, wherein
the motor includes a rotor, a stator, a rotation shaft coupled to the rotor, and a slide bearing supporting the rotation shaft, and supplies the refrigerant from the refrigerant passage between the rotor and the stator, and
the motor cooling system further comprises, in addition to the refrigerant passage:
a refrigerant passage for supplying the refrigerant to the slide bearing; and
an oil passage for supplying the oil to the slide bearing.
